(19) United States
(12) Patent Application Publication
(10) Pub. No.: US 2017/0235130 A1
(43) Pub. Date: Aug. 17, 2017

(54) CURVED LENS PROTECTOR

(71) Applicant: Matthew Baker, Sandy, UT (US)

(72) Inventor: Matthew Baker, Sandy, UT (US)

(21) Appl. No.: 15/422,745

(22) Filed: Feb. 2, 2017

Related U.S. Application Data
(63) Continuation-in-part of application No. 15/013,124, filed on Feb. 2, 2016.

(51) Int. Cl. G02B 27/00; G02C 7/02

(52) U.S. Cl. CPC G02B 27/0006; G02C 7/02

(57) ABSTRACT

A curved lens protector can include a tempered glass body having a self-supporting x-y axis curve with a concave inner surface and a convex outer surface opposite the inner surface. The tempered glass body can have an outer boundary of a predetermined shape to substantially match and fit with respect to an inner boundary of a lens holder portion of a predetermined lens frame. The tempered glass body can be configured for attachment to a predetermined curved lens without the use of an adhesive.

The present application is a Continuation-In-Part of U.S. patent application Ser. No. 15/013,124, filed on Feb. 2, 2016, the entirety of which is incorporated herein by reference.

### BACKGROUND

Lenses are used in a variety of applications including vision correction, image magnification, optical research, and others. For example, curved lenses are used in a variety of consumer eyeglasses, such as prescription eyeglasses and sunglasses, to improve the quality of life of the consumer. Typically, a curved lens is made of glass or plastic and is ground or cut to a specific shape and thickness from a lens blank to match a particular frame and/or prescription. Some lenses can also be coated or tinted to provide sunlight protection, UV protection, or other advantageous features for the consumer.

### BRIEF DESCRIPTION OF THE DRAWINGS

For a fuller understanding of the nature and advantage of the present invention, reference is being made to the following detailed description of various embodiments in connection with the accompanying drawings, in which:

FIG. 1A illustrates an example of a curved lens protector, according to one aspect of the present disclosure;

FIG. 1B illustrates a cross-sectional view of an example curved lens protector cut along an x-axis, according to one aspect of the present disclosure;

FIG. 1C illustrates a cross-sectional view of an example curved lens protector cut along a y-axis, according to one aspect of the present disclosure;

FIG. 2 illustrates an example of a curved lens protector applied to a single lens of a pair of eyeglasses;

FIG. 3A illustrates an example of a sheet of polymer material from which a curved lens protector can be cut;

FIG. 3B illustrates an example of a sheet of polymer material applied to a mold, the sheet of material having been cut;

FIG. 3C illustrates an example of a curved lens protector formed via compression molding; and

FIG. 3D illustrates an example of a curved lens protector formed via injection molding.

### DETAILED DESCRIPTION

Lenses are used in a variety of applications including vision correction, image magnification, optical research, eye protection from sunlight or UV light, glare removal, and others. For example, lenses are employed in a variety of consumer eyeglasses, such as prescription eyeglasses and sunglasses, to improve the quality of life of the consumer. However, lenses tend to be somewhat fragile and can be easily broken, scratched, or otherwise damaged. At a minimum, this can diminish the value of the lens for its intended purpose. In some cases, the damage to the lens can render it inoperable for its intended function. Thus, it would be advantageous to provide a lens protector for preventing these fragile lenses from being damaged, and thus, prolong their effective life for the consumer.

Accordingly, a lens protector is described herein that can help prevent or minimize damage to a lens. Further, because lenses are typically curved, the lens protectors described herein are curved to provide improved fit as well as to reduce unwanted delamination of the lens protector from the underlying lens.

In one embodiment, a curved lens protector is described. The curved lens protector can include a transparent body having a self-supporting x-y axis curve with a concave inner surface and a convex outer surface opposite the inner surface. The transparent body can have an outer boundary of a predetermined shape to substantially match and fit within an inner boundary of a lens holder portion of a predetermined lens frame. The transparent body can also be configured for attachment to a predetermined curved lens. In some examples, an adhesive may be used, and in other examples, the attachment can be without the use of an adhesive. Examples of materials for use for the transparent body include tempered glass, or in other examples, polymers such as polyurethane, polyethylene terephthalate, polymethyl methacrylate, polycarbonate, polyvinyl chloride, and combinations thereof.

In another example, a method of manufacturing a curved lens protector is described. The method can include molding a transparent body to have a self-supporting x-y axis curve with a concave inner surface and a convex outer surface opposite the inner surface. Further, the method can include forming an outer boundary of the transparent body to a predetermined shape to substantially match and fit within an inner boundary of a lens holder portion of a predetermined lens frame. Again, examples of materials for use for the transparent body include tempered glass, or in other examples, polymers such as polyurethane, polyethylene terephthalate, polymethyl methacrylate, polycarbonate, polyvinyl chloride, and combinations thereof.

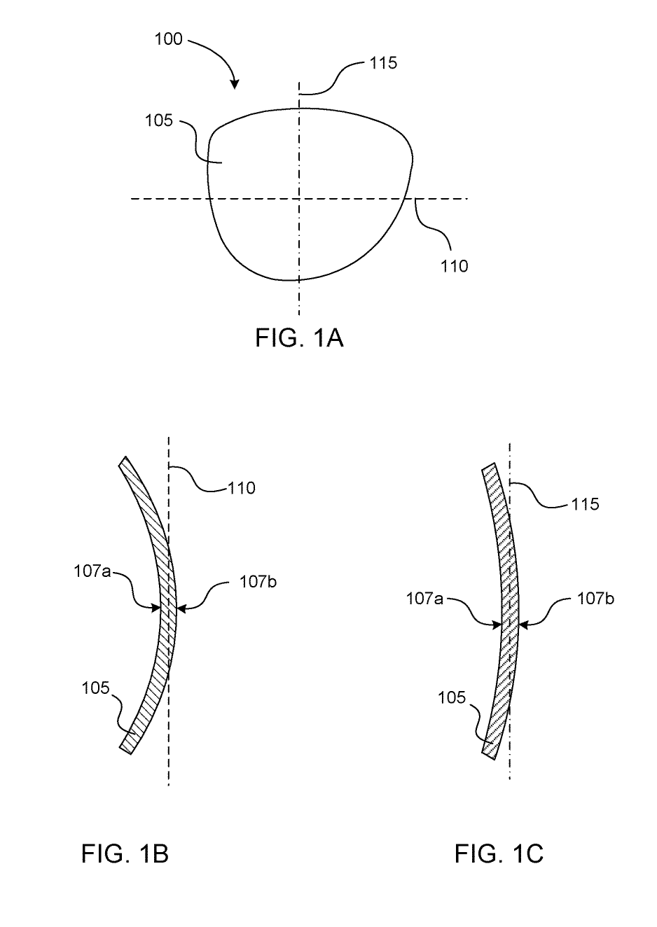

A non-limiting example of a curved lens protector 100 is illustrated in FIGS. 1A-1C. The curved lens protector 100 can have a transparent body 105 having a self-supporting x-y axis curve. The term “transparent body” here includes tempered glass as well as clear polymer films, as well as colored, darkened, coated, or polarized films, provided they have a clear, non-cloudy or non-milky, appearance to a viewer looking through the transparent body. Thus, even when color, tint, UV protection, and/or polarization added, the body is still considered to be transparent. The term “self-supporting,” means that the curved lens protector retains the x-y axis curve independent of another structure and does not need to be applied to another structure, such as a mold, frame, lens, or other form to or retain its x-y axis curve. In other words, the bias or shape of lens protector or transparent body at rest is to retain the x-y curvature, even without any support from another structure, e.g., lens, mold, packaging support, etc. In some examples, while the x-y axis curve of the lens protector may be able to be modestly adjusted upon application to another structure, the lens protector can revert back to its self-supporting x-y axis curve upon removal from the structure.

Returning to FIG. 1A, an x-axis 110 and a y-axis 115 of a curved lens protector are represented. Thus, by x-y axis curve, it is meant that the curved lens protector is curved about both the x-axis (i.e. curved from top to bottom) and y-axis (i.e. curved from left to right). For example, a cross-sectional view of a curved lens protector is illustrated in FIG. 1B where the transparent body 105 has been cut along the x-axis 110, illustrating the curve of the lens about the y-axis. Similarly, a cross-sectional view of a curved lens protector is illustrated in FIG. 1C where the transparent body 105 has been cut along the y-axis 115, illustrating the curve about the x-axis. As illustrated in these figures, the transparent body 105 can have a concave inner surface 107a and a convex outer surface 107b opposite the inner surface.

In some examples, the radius of curvature about the x-axis and the radius of curvature about the y-axis can be equivalent, producing a spherical shape or spherical x-y axis curve. It is understood that the term “spherical” defines the curvature and does not infer a complete spherical shape, but rather a portion of the spherical curvature. However, as illustrated by FIGS. 1B and 1C the radii of curvature about the x- and y-axes need not be the same. In other words, the x-y axis can have a toric or elliptical shape or x-y axis curve. In some examples, the radius of curvature about the x-axis can be greater than the radius of curvature about the y-axis. In other examples, the radius of curvature about the y-axis can be greater than the radius of curvature about the x-axis. In still other examples, either or both of the x-axis and/or y-axis may not have a semispherical curvature, but rather is arcuate with a changing curvature along the axis. Regardless, there is a curvature, though not always well defined.

Whether the x-y axis curve is spherical or toric in shape (or otherwise) can depend on the lens to which the curved lens protector will be applied or the type of fit desired for the lens protector. For example, the lens protector can be designed or shaped to match a particular lens configuration such that the x-y axis curve of the lens protector can match, conform, or substantially conform to the curve of a predetermined curved lens. In other examples, the curved lens protector can have the same, a slightly larger, or slightly smaller radius of curvature (or other curvature profile) than the lens to bias the curved lens protector toward the lens. In one example, the x-y axis can be generally more curved than the curve of a predetermined curved lens (along one axis or both of the axes). This can provide a slight bias to prevent the outer boundary of the transparent body from becoming separated from the predetermined curved lens. However, it should be noted that in some cases too much of a bias toward the predetermined curved lens can also cause the curved lens protector to inadvertently release from the surface of the lens. In some examples, the curved lens protector can have a radius of curvature that is from 60% to less than 100% of the radius of curvature of the predetermined curved lens. In other examples, the curved lens protector can have a radius of curvature that is from 70% to 99% of the radius of curvature of the predetermined curved lens. In other examples, the curved lens protector can have a radius of curvature that is from 80% to 98% of the radius of curvature of the predetermined curved lens. In other examples, the radius of curvature can be greater than the curvature of the curved lens, e.g., from greater than 100% to 130%. In the case of tempered glass, the radius of curvature may be from 85% to less than 100%, or from greater than 100% to 115%, for example. Ranges outside of these can also be used, and thus, these ranges are used for general guidance.

To illustrate, in an embodiment where the curved lens protector has a radius of curvature from 60% to less than 100% of the radius of curvature of the predetermined curved lens, and where the predetermined curved lens has a radius of curvature of 10 mm, the curved lens protector can have a radius of curvature from 6.0 mm to less than 10 mm. It is noted that where the curved lens has a toric or elliptical shape, this same principle applies to each respective curvature of the curved lens. For example, where the curved lens has a radius of curvature about the x-axis of 10 mm, the radius of curvature of the curved lens protector about the x-axis can be from 6.0 mm to less than 10 mm. If the curved lens has a radius of curvature about the y-axis of 8 mm, the curved lens protector can have a radius of curvature about the y-axis from 4.8 mm to less than 8 mm. If the curvature of the lens is other than semi-spherical along one or both of its axes, then appropriate related curvature can likewise be used, e.g., match the curvature, or be slightly more or less curved.

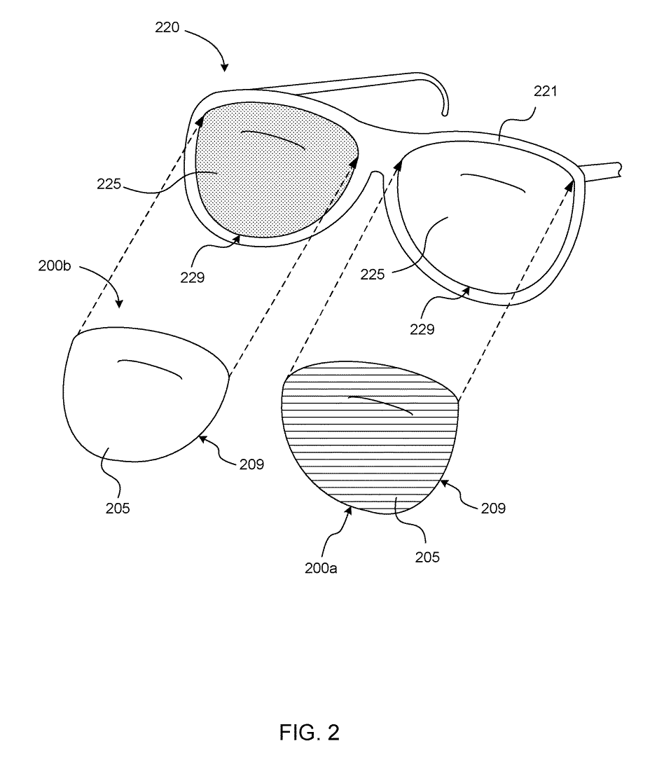

The outer boundary of the transparent body can be formed into a variety of shapes, and furthermore, various arrangements can be prepared. As illustrated in FIG. 2, a curved and tinted or polarized lens protector 200a has been fitted onto a lens of a lens holder portion 221 of a predetermined lens frame 220. The term “lens frame” includes any lens holder that supports a lens in use, such as glasses or sunglasses frames, goggle frames, magnifier frames, or the like. Shown in this example is a standard glasses or sunglasses frame. Alternatively, a curved clear lens protector 200b is illustrated separately from the lens frame 220, but has been configured for application to an already tinted sunglasses lens 225. In each case (200a and 200b), the curved lens protector has a transparent body 205 (200a transparent and tinted and/or polarized and 200b transparent and clear) with an outer boundary 209 of a predetermined shape to substantially match and fit with respect to an inner boundary 229 of a lens holder portion of the predetermined lens frame 220. By “substantially match,” it is meant that the outer boundary of the curved lens protector can align within about 1 mm of the inner boundary of the lens holder and/or cover at least about 95% of the exposed surface of the predetermined lens on the side where the curved lens protector is applied. In certain embodiments where the lenses are removable from the frame, there may be examples where the lens protector is slightly larger than the inner boundary of the frame, e.g., lens removed and protected and then the entire lens and lens protector assembly is fit under a ridge of the frame designed to hold the lens in place such as used in the interchangeable lens system by Smith. Thus, when describing that a predetermined shape “substantially matches” or fits “with respect to” an inner boundary of a frame, each of these arrangements, and other similar arrangements, are contemplated.

The curved lens protector 200a and 200b can be applied to lens 225 of frame 220 to provide a natural look and feel to the glasses while maintaining ease of removal and re-application. In other embodiments, the transparent body can be adhered to a curved mold or packaging support that is other than a lens, as will be discussed in further detail below. Furthermore, curved lens protector can be configured to attach to a predetermined curved lens without the use of an adhesive. For example, the curved lens protector can be configured for attachment to a lens via electrostatic adhesion. Alternatively, an adhesive may be used to attach the curved lens protector to the curved lens. Examples of adhesives that may be used include various adhesive polymers, such as acrylics, butyl rubbers, ethylene-vinyl acetates, natural rubbers, silicone rubbers, styrene copolymers such as styrene/butadienes, styrene/ethylene/butylenes, styrene/ethylene/propylenes, styrene/isoprene, etc., vinyl ethers, or the like. Combinations of these or other polymers can likewise be used. Adhesives can be applied as a thin layer, e.g., from about 500 nm to about 100 μm. The adhesive material can be applied to the curved lens protector in any manner that is suitable, including spraying, rolling, printing, stamping, and the like. Additionally, whether or not an adhesive is used, a release liner may also be included that protects the concave inner surface from dust or other particles/debris, fingerprints, etc., prior to application to the curved lens. The release liner can conform to the concave inner surface, and can include materials such as polyethylene, polypropylene, polyester, or the like. In some examples, the release liner can include a release coating, such as a silicone release coating, or other coating that allows the release liner to be easily removed without removing the adhesive (if present) from the concave inner surface. Again, in certain examples, the release can adhere to the concave inner surface via electrostatic interactions without the use of an adhesive.

Further, as illustrated in FIG. 2 and previously described, in some examples the curved lens protector can be tinted, colored, polarized, coated, etc., as shown at 200a to provide UV, sunlight, glare, and/or other protection to a standard pair of eyeglasses. In other examples, the curved lens protector can be devoid of colorants or tints and be clear in appearance. However, even clear lens protectors can have protection included therein, such as UV protection absorbers, anti-reflective coatings, anti-scratch coatings, and/or other functional additives or coatings.

The transparent body can be made of a variety of materials, such as tempered glass or polymers. In some examples, the material can be any suitable transparent polymer material that facilitates electrostatic adhesion to a lens, or can be otherwise adhered to the lens, such as by using a clear adhesive. Again, in one example, the material can be a tempered glass. Alternatively, polymer can be used. Thermoplastic materials, for example, can be used, such as a thermoplastic polyurethane. In other examples, the transparent body can be made of a material selected from the group consisting of polyurethane, polyethylene terephthalate, polymethyl methacrylate, polycarbonate, polyvinyl chloride, and combinations thereof. In another example, the transparent body can be made of polyurethane.

The transparent body can have a variety of thicknesses. It can be advantageous to have a curved lens protector that is sufficiently thick to provide protection to the underlying lens while maintaining a natural look and feel to the glasses. Further, in some cases, where the lens protector becomes too thick, it can lack sufficient flexibility for a suitable and conforming adhesion to the underlying lens. In some examples, the transparent body can have a thickness from 0.025 mm to 1 mm, or from 0.025 mm to 0.75 mm. In other examples, the transparent body can have a thickness from 0.05 mm to 0.7 mm. In yet other examples, the transparent body can have a thickness from 0.1 mm to 0.5 mm.

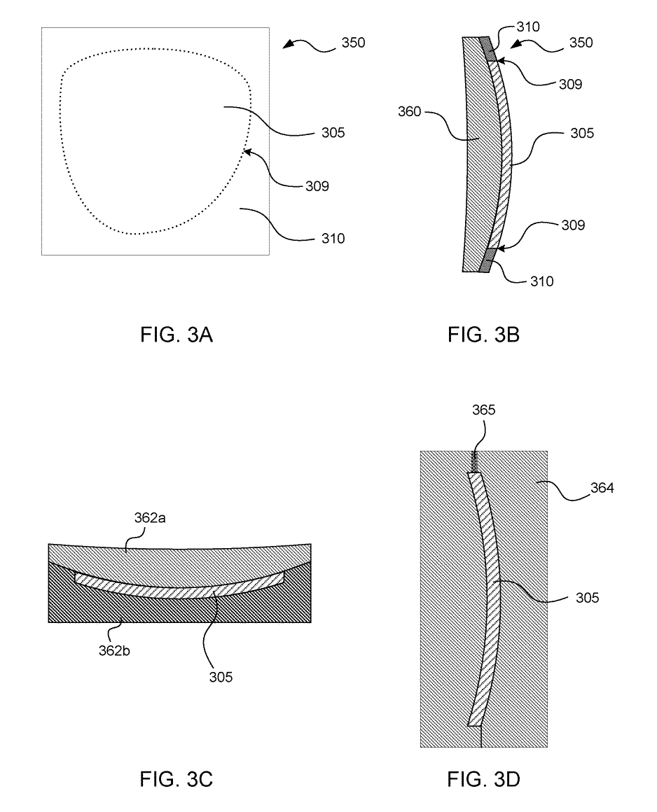

Thus, a variety of curved lens protectors are described herein. Such curved lens protectors can be manufactured in a number of ways, some examples of which are illustrated in FIGS. 3A-3D. In one embodiment, as illustrated in FIGS. 3A-3B, molding of the transparent body 305 can be performed by thermoforming. Thermoforming can include any method where a sheet of material 350 is heated and applied to a mold 360 to prepare a transparent body having a predetermined x-y axis curve (as previously illustrated in FIGS. 1A-1C). In one aspect, the sheet of material can be heated prior to application to the mold to prepare a transparent body having a predetermined x-y axis curve. In another aspect, the sheet of material can be applied to the mold and subsequently heated to prepare a transparent body having a predetermined x-y axis curve. Thus, the transparent body can be adhered to a curved mold that is other than the curved lens. In some examples, the transparent body can be adhered to a reusable curved mold during manufacturing. Additionally, in some examples, the transparent body can be adhered to a curved structure for packaging and distribution. In other examples, the mold used to form the transparent body or lens protector can also be the curved structured used for packaging.

In further detail with respect to FIGS. 3A and 3B, forming the outer boundary 309 of the transparent body 305 into a predetermined shape can be performed in a variety of ways. In one aspect, the outer boundary can be formed via laser cutting. With laser cutting, a controller can be programmed direct a laser to cut one of a wide variety of lens protector shapes and configurations to substantially match and fit with respect to an inner boundary of a lens holder portion of a predetermined lens frame. For example, as illustrated in FIGS. 3A-3B, a controller can be programmed to cut an outer boundary of a transparent body from of a sheet of material 350. In one aspect, the outer boundary can be cut prior to application to a mold 360. In another aspect, as illustrated in FIG. 3B, the entire sheet can be applied to the mold and subsequently the outer boundary of the transparent body can be laser cut from the sheet of material, leaving an unused extra portion 310 on the mold. When using, this portion can be removed first to make it easier to access removal of the transparent body or lens protector. In the example shown in FIGS. 3A and 3B, only the sheet of material is shown as being cut; however, in some examples, the mold may be a disposable or one time use mold that is cut with the transparent body or lens protector to be packaged with the lens protector.

While laser cutting has a number of advantages, a variety of mechanical cutting techniques can also be used in a similar manner. In one aspect, the outer boundary can be formed via die cutting. In this case, a number of dies can be prepared to cut a wide variety of lens protector shapes and configurations to substantially match and fit with respect to an inner boundary of a lens holder portion of a predetermined lens frame. Further, rotational cutting, or sawing, can also be used to form the outer boundary of the curved lens protector. These methods can also employ a numerical control to program a blade or cutting member to cut a number of patterns to match a predetermined lens holder portion of a lens frame. Other similar methods can also be used to form the outer boundary of the transparent body.

In another embodiment, as illustrated in FIG. 3C, molding of the transparent body 305 can be performed by compression molding. Compression molding can include any method where a material is introduced into a mold basin or cavity 362b and subsequently compressed with a molding plug 362a to prepare a transparent body having a predetermined x-y axis curve. In another embodiment, as illustrated in FIG. 3D, molding of the transparent body 305 can be performed by injection molding. Injection molding can include any method where a heated material is introduced into a mold 364 via an injection channel 365 and allowed to cool within the mold to prepare a transparent body having a predetermined x-y axis curve. While one or more of these methods can generally be employed to mold the transparent body, there are other methods that can also be employed that will be apparent to those skilled in the art.

Notably, these various methods of forming the curved transparent body can be carried out to different degrees of success, depending on the material selected for use. When using a polymer for the curved transparent body, these methods can each be generally carried out. However, some of these methods may be more difficult when using tempered glass for example. For example, when preparing a tempered glass curved transparent body, thermoforming or molding may be desirable methods of preparation. To illustrate one example, a tempered glass curved transparent body may be prepared as using various steps. In one example, a thin glass starting material can be generally shaped by die cutting, cutting, drilling, milling, thermoforming, molding, and/or chamfering. The glass can be positioned over a convex mold and heated where the glass falls or is otherwise applied to the convex surface. The softened glass can thus contact the convex mold toward the structure. Thus, the glass becomes softened to the point where it can be shaped along the surface of the mold, and then in some examples, die cut or punched thereon. Softening temperatures can be from 450° to 900° C., for example. Thus, a combination of the heat, contact with the mold, and punching the shape of the tempered glass can be used to form the tempered glass curved transparent body. The glass can be held there for an amount of time so that the glass cools, e.g., below 50° C., for example. The rate of both heating and cooling can be controlled to avoid damage to the glass. Suitable molds can be made from quartz glass, ceramics such as alumina, zirconia, nitrides, etc. The heating equipment may be various types of furnaces, stoves, push plates, etc. This technique can also be used for polymer curved transparent bodies, though the temperatures, etc., used would likely be different.

A template can likewise be used for preparing one or more curved transparent bodies. For example, a flat sheet template may have a plurality of openings there through that are larger in size than the size of the curved transparent body that that is being prepared. Thus, a sheet of glass can be applied to a surface of the flat template, over multiple openings, and when the glass is heated, the glass can soften and protrude through the openings onto the mold. Thus protrusion can occur by gravity or by vacuum pressure. For example, negative vacuum pressure can be used to pull the softened transparent body material through the template openings and onto the mold, or positive vacuum pressure can be used to push the glass through the openings and onto the mold. Either of these techniques (vacuum or gravity) can be carried out in combination with moving the template and the mold closer together. The vacuum, if used, can provide good contact between the transparent body material and the mold, while removing air bubbles between the transparent body material and the mold during the molding process. That being stated, the use of a vacuum is not required, as softening of glass and allowing the glass to fall or deform downward onto the mold may be a technique that is alternatively used.

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a polymer material” includes a plurality of such polymer materials.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. For example, when using an open ended term, like “comprising” or “including,” in this specification it is understood that direct support should be afforded also to “consisting essentially of” language as well as “consisting of” language as if stated explicitly.

If a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. In accordance with the present disclosure, for example, the phrase that a lens protector can “substantially match” and fit with respect to an inner boundary of a lens holder portion of a predetermined lens frame, allows for some degree of flexibility. For example, under this definition, the lens protector can exactly match the inner boundary of the lens frame, or can be just slightly smaller than the inner boundary at one or more location, leaving a small gap. However, such a small gap would be small enough so as to not be noticeable to the wearer of the glasses with the lens protector in place, e.g., less than 1 mm, less than 0.5 mm, etc. In certain examples where the lenses are removable from the frame, there may be examples where the lens protector is slightly larger than the inner boundary of the frame, e.g., lens removed and protected and then the entire lens and lens protector assembly is fit under a ridge of the frame designed to hold the lens in place.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 angstroms to about 80 angstroms” should also be understood to provide literal support for the range of “50 angstroms to 80 angstroms.” For example, the recitation of “about” 50 should be construed as not only providing support for values a little above and a little below 30, but also for the actual numerical value of 30 as well.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Ranges, sizes, distances, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

It should be understood that the above-described curved lens protectors and associated methods are only illustrative of some embodiments in accordance with the present disclosure. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that variations may be made without departing from the principles and concepts set forth herein.

What is claimed is:

1. A curved lens protector, comprising a tempered glass body having a self-supporting x-y axis curve with a concave inner surface and a convex outer surface opposite the inner surface, wherein the tempered glass body has an outer boundary of a predetermined shape to substantially match and fit with respect to an inner boundary of a lens holder portion of a predetermined lens frame, and wherein the tempered glass body is configured and shaped for attachment to a predetermined curved lens.

2. The curved lens protector of claim 1, wherein the tempered glass body is configured for attachment to the predetermined curved lens without the use of an adhesive.

3. The curved lens protector of claim 1, wherein the tempered glass body includes an adhesive applied to at least a portion of the concave inner surface.

4. The curved lens protector of claim 1, wherein the x-y axis curve has a generally spherical shape.

5. The curved lens protector of claim 1, wherein the x-y axis curve has a generally toric shape.

6. The curved lens protector of claim 1, wherein the x-y axis curve matches a curve of the predetermined curved lens.

7. The curved lens protector of claim 1, wherein the x-y axis curve is more curved than a curve of the predetermined curved lens, thereby providing a force along the outer boundary of the tempered glass body that biases toward the predetermined curved lens when the tempered glass body is fully adhered to the predetermined curved lens.

8. The curved lens protector of claim 1, wherein a radius of curvature of the x-y axis curve of the tempered glass body is from 85% to less than 100% of the radius of curvature of the x-y axis curve of the predetermined curved lens.

9. The curved lens protector of claim 1, wherein a radius of curvature of the x-y axis curve of the tempered glass body is from greater than 100% to 115% of the radius of curvature of the x-y axis curve of the predetermined curved lens.

10. The curved lens protector of claim 1, wherein the tempered glass body has a thickness of from 0.025 mm to 1 mm.

11. The curved lens protector of claim 1, wherein the tempered glass body is configured for attachment to a lens via electrostatic adhesion.

12. The curved lens protector of claim 1, wherein the tempered glass body further comprises a UV absorber or a UV absorber coating.

13. The curved lens protector of claim 1, wherein the tempered glass body is adhered to a curved mold or curved packaging support.

14. The curved lens protector of claim 1, wherein the tempered glass body is removable and re-applyable to the predetermined curved lens.

15. The curved lens protector of claim 1, wherein the outer boundary or the tempered glass body fits within the inner boundary of a lens holder.

16. The curved lens protector of claim 1, wherein the outer boundary or the tempered glass body substantially matches the shape of the predetermined curved lens, and wherein the outer boundary of the tempered glass body fits beneath the inner boundary of the lens holder.

17. A method of manufacturing a curved lens protector, comprising:
molding a tempered glass body to have a self-supporting x-y axis curve with a concave inner surface and a convex outer surface opposite the inner surface; and
forming an outer boundary of the tempered glass body to a predetermined shape to substantially match and fit with respect to an inner boundary of a lens holder portion of a predetermined lens frame.

18. The method of claim 17, wherein molding of the tempered glass body is performed by compression molding or thermoforming.

19. The method of claim 17, wherein the tempered glass body is molded to match a specific x-y axis curve of a predetermined curved lens.

20. The method of claim 17, wherein forming the tempered glass body is performed via die cutting the tempered glass when the tempered glass has been softened by heating on a mold.
